(19) United States
(12) Patent Application Publication
(10) Pub. No.: US 2013/0115440 A1
(43) Pub. Date: May 9, 2013

(54) COMPOSITES

(71) Applicants: Bernd Hoevel, Sinzheim (DE); Martine M. Rousse, Drusenheim (FR); Alain M. Sagnard, Drusenheim (FR); Marvin L. Dettloff, Lake Jackson, TX (US); Radhakrishnan Karunakaran, Lake Jackson, TX (US)

(72) Inventors: Bernd Hoevel, Sinzheim (DE); Martine M. Rousse, Drusenheim (FR); Alain M. Sagnard, Drusenheim (FR); Marvin L. Dettloff, Lake Jackson, TX (US); Radhakrishnan Karunakaran, Lake Jackson, TX (US)

(21) Appl. No.: 13/700,229

(22) PCT Filed: May 27, 2011
(86) PCT No.: PCT/US11/00968

§ 371 Date: Nov. 27, 2012

Related U.S. Application Data
(60) Provisional application No. 61/349,509, filed on May 28, 2010.

(51) Int. Cl. B32B 5/18; C08G 59/44; C08G 59/42; C08G 59/50

(52) U.S. Cl. CPC B32B 5/18; C08G 59/504; C08G 59/444; C08G 59/4238
USPC 428/304.4; 525/390; 525/397; 156/305; 156/285; 264/263

(57) ABSTRACT

Embodiments include methods of forming a composite. The methods can include providing a foam core, wherein the foam core includes a foam having a softening point of 90° C. to 110° C., covering a portion of the foam core with a prepreg, contacting the prepreg that covers the portion of the foam core with a curable composition, and curing the prepreg and the curable composition to form the composite, wherein the prepreg insulates the foam core during the curing so that the foam maintains a temperature that is below the softening point. Embodiments include a composite obtained by curing the prepreg and the curable composition. Embodiments include B-stageable formulation having a resin component and a hardener component.

### FIELD OF DISCLOSURE

This disclosure relates to composites and methods of forming composites.

### BACKGROUND

Epoxy systems may consist of two components that can chemically react with each other to form a cured epoxy, which is a hard, inert material. The first component can be an epoxy resin and the second component can be a curing agent, sometimes called a hardener. Epoxy resins are substances or mixtures that contain epoxide groups. The hardener includes compounds which are reactive to the epoxide groups of the epoxy resins.

The epoxy resins can be crosslinked, also referred to as curing, by the chemical reaction of the epoxide groups and the compounds of the hardener. This curing converts the epoxy resins into crosslinked materials by chemical reaction with the hardener.

Composite materials can be formed by combining two or more materials. The cured epoxy resins can be included in composite materials. Composite materials utilize the differing characteristics of the different materials.

### SUMMARY

The present disclosure provides one or more embodiments of a method of forming a composite. Methods of forming the composite can include providing a foam core, wherein the foam core includes a foam having a softening point of 90° C. to 110° C., covering a portion of the foam core with a prepreg, contacting the prepreg that covers the portion of the foam core with a curable composition, and curing the prepreg and the curable composition to form the composite, wherein the prepreg insulates the foam core during the curing so that the foam maintains a temperature that is below the softening point.

For one or more of the embodiments, the present disclosure provides a composite obtained by curing the prepreg and the curable composition.

The present disclosure provides one or more embodiments of a B-stageable formulation that includes a resin component and a hardener component.

### BRIEF DESCRIPTION OF THE FIGURES

FIG. 1 is a graphical illustration that illustrates heat flow data of curable composition 1, and B-stageable formulation, Example 10.

FIG. 2 is a graphical illustration that illustrates viscosity increase at 40° C. of curable composition 1, and B-stageable formulation, Example 10.

FIG. 3 is a graphical illustration that illustrates exothermic cure temperatures for 100 grams of curable composition 1, and B-stageable formulation, Example 10.

FIG. 4 is a graphical illustration that illustrates exothermic cure temperatures for 1,000 grams of curable composition 1, and B-stageable formulation, Example 10.

### DETAILED DESCRIPTION

As used herein, composites are materials that are formed from two or more components that have distinct mechanical properties. The components of the disclosed composites can have various configurations. For example, the components of the disclosed composites can be layered. The layered component composite can be referred to as a sandwich structure, such that a first component, either entirely or a portion thereof, of the composite is encapsulated by one or more other components of the composite. The layered component composite can help provide that heat sensitive materials, e.g. a form core, can be utilized for the composites. For some composite forming applications, such as an infusion process, a core can be placed within a mold and thereafter contacted with a curable composition. For infusion processes the curable composition can be injected into the mold. The curable composition is then cured to form the composite consisting of a hard, inert cured material encasing, e.g. encapsulating, the core. This curing releases heat generated by the exothermic curing reaction. Examples of composites include, but are not limited to, boat hulls, bicycle frames, racing car bodies, wind turbine blades, fishing rods, storage tanks, and aerospace components including tails, wings, fuselages, propellers, among others.

Materials available for use for the core have been limited due to the heat released by the exothermic curing reactions and the methods employed in forming the composites. Some materials, and in particular some foams, are heat sensitive such that exposing those materials to a temperature above a critical temperature for a critical period of time can result in a deformation and/or a degradation of those materials. Deformed and/or degraded core materials can result in an undesirable composite. A foam is a dispersion in which a large proportion of gas by volume in the form of gas bubbles is dispersed in a liquid, solid or gel. The foam's cells can have a diameter of 0.1 millimeters (mm) to 0.6 mm, 0.2 mm to 0.5 mm, or 0.3 mm to 0.4 mm. Herein, the recitations of numerical ranges by endpoints include all numbers subsumed within that range (e.g., 1 to 5 includes 1, 1.5, 2, 2.75, 3, 3.80, 4, 5, etc.). However, other diameters of the foam's cells are possible.

Embodiments of the present disclosure provide composites, components of the composites, and/or methods of forming the composites from the components that can include a foam core, a prepreg, and a curable composition. The prepreg, which is obtainable from a B-stageable formulation as disclosed herein, can function as a heat sink and/or thermal insulator to the foam core. This can help provide that the external surface of the foam core does not reach a temperature whereby thermal degradation of the foam can occur. For one or more of the embodiments, the foam core includes a foam having a softening point of 90° C. or greater. For example, the foam core can include a foam having a softening point of 90° C., 95° C., or 98° C. For one or more of the embodiments, the foam core includes a foam having a softening point of 110° C. or less. For example, the foam core can include a foam having a softening point of 110° C., 105° C., or 102° C. For one or more of the embodiments, the foam core includes a foam having a softening point of for example, 90° C. to 110° C., 95° C. to 105° C., or 98° C. to 102° C. Foams having a softening point in this range have been undesirable for some composite applications due to possible degradation from the exothermic curing reactions. Surprisingly, embodiments of the present disclosure help provide that these foams can be utilized for composites, while reducing the possibility of degradation due to the exothermic curing reactions.

One process for determining the softening point of the foam is ASTM D 1525. The foam can be a crosslinked foam, a non-crosslinked foam, or combinations thereof. Examples of the foam include, but are not limited to, polystyrene foam, polyvinyl chloride foam, polyurethane foam, styrene-acrylonitrile foam, polymethacrylamide foam, polyethylene terephthalate foam, and combinations thereof. For one or more embodiments, methods of forming the composites include providing a foam core, wherein the foam core includes a foam having a softening point of 90° C. to 110° C.

For one or more embodiments, methods of forming the composites include a prepreg. The prepreg can be formed by a process that includes contacting a prepreg reinforcement component and a prepreg matrix component. The prepreg matrix component surrounds and/or supports the prepreg reinforcement component. These prepreg components can impart mechanical and/or physical properties to the prepreg.

B-stageable formulations can be used for the prepreg matrix component. The B-stageable formulations include a resin component that includes an epoxy compound. As used herein, a compound is a substance composed of atoms or ions of two or more elements in chemical combination and an epoxy compound is a compound in which an oxygen atom is directly attached to two adjacent or non-adjacent carbon atoms of a carbon chain or ring system.

For one or more of the embodiments, the resin component can have an epoxy equivalent weight of 400 grams per equivalent or greater. For example, the resin component can have an epoxy equivalent weight of 400 grams per equivalent, 410 grams per equivalent, or 425 grams per equivalent. For one or more of the embodiments, the resin component can have an epoxy equivalent weight of 500 grams per equivalent or less. For example, the resin component can have an epoxy equivalent weight of 500 grams per equivalent, 490 grams per equivalent, or 475 grams per equivalent. For one or more embodiments, the resin component can have an epoxy equivalent weight of, for example, 400 grams per equivalent to 500 grams per equivalent, 410 grams per equivalent to 490 grams per equivalent, or 425 grams per equivalent to 475 grams per equivalent. Epoxy equivalent weight can be calculated as the mass of resin component containing one mole of epoxide groups.

The epoxy compound can be selected from the group consisting of aromatic epoxy compounds, alicyclic epoxy compounds, aliphatic epoxy compounds, and combinations thereof. Examples of aromatic epoxy compounds include, but are not limited to, glycidyl ether compounds of polyphenols, such as hydroquinone, resorcinol, bisphenol A, bisphenol F, 4,4′-dihydroxybiphenyl, phenol novolac, cresol novolac, trisphenol (tris-(4-hydroxyphenyl)methane), 1,1,2,2-tetra(4-hydroxyphenyl)ethane, tetrabromobisphenol A, 2,2-bis(4-hydroxyphenyl)-1,1,1,3,3,3-hexafluoropropane, 1,6-dihydroxynaphthalene, and combinations thereof.

Examples of alicyclic epoxy compounds include, but are not limited to, polyglycidyl ethers of polyols having at least one alicyclic ring, or compounds including cyclohexene oxide or cyclopentene oxide obtained by epoxidizing compounds including a cyclohexene ring or cyclopentene ring with an oxidizer, and combinations thereof. Some particular examples include, but are not limited to, hydrogenated bisphenol A diglycidyl ether; 3,4-epoxycyclohexylmethyl-3,4-epoxycyclohexyl carboxylate; 3,4-epoxy-1-methylcyclohexyl-3,4-epoxy-1-methylhexane carboxylate; 6-methyl-3,4-epoxycyclohexylmethyl-6-methyl-3,4-epoxycyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate; bis(3,4-epoxycyclohexylmethyl)adipate; methylene-bis(3,4-epoxycyclohexane); 2,2-bis(3,4-epoxycyclohexyl)propane; dicyclopentadiene diepoxide; ethylene-bis(3,4-epoxycyclohexane carboxylate); dioctyl epoxyhexahydrophthalate di-2-ethylhexyl epoxyhexahydrophthalate; and combinations thereof.

Examples of aliphatic epoxy compounds include, but are not limited to, polyglycidyl ethers of aliphatic polyols or alkylene-oxide adducts thereof, polyglycidyl esters of aliphatic long-chain polybasic acids, homopolymers synthesized by vinyl-polymerizing glycidyl acrylate or glycidyl methacrylate, and copolymers synthesized by vinyl-polymerizing glycidyl acrylate or glycidyl methacrylate and other vinyl monomers, and combinations thereof. Some particular examples include, but are not limited to glycidyl ethers of polyols, such as 1,4-butanediol diglycidyl ether; 1,6-hexanediol diglycidyl ether; a triglycidyl ether of glycerin; a triglycidyl ether of trimethylol propane; a tetraglycidyl ether of sorbitol; a hexaglycidyl ether of dipentaerythritol; a diglycidyl ether of polyethylene glycol; and a diglycidyl ether of polypropylene glycol; polyglycidyl ethers of polyether polyols obtained by adding one type, or two or more types, of alkylene oxide to aliphatic polyols such as propylene glycol, trimethylol propane, glycerin; and diglycidyl esters of aliphatic long-chain dibasic acids, and combinations thereof.

The B-stageable formulations include a hardener component. The hardener component is selected from the group consisting of aromatic amines, aliphatic amines, anhydrides, and combinations thereof.

For one or more of the embodiments, the hardener component includes an amine. An amine is a compound that contains a N—H (nitrogen-hydrogen) moiety. Examples of aromatic amines include, but are not limited to, m-phenylenediamine, diaminodiphenylmethane, sulfanilamide, 4,4′-diaminodiphenyl sulphone, and combinations thereof. Examples of aliphatic amines include, but are not limited to, ethylenediamine, diethylenetriamine, triethylenetetramine, trimethyl hexane diamine, hexamethylenediamine, dipropylenetriamine, and combinations thereof.

For one or more of the embodiments, the hardener component includes an anhydride. An anhydride is a compound having two acyl groups bonded to the same oxygen atom. The anhydride can be symmetric or mixed. Symmetric anhydrides have identical acyl groups. Mixed anhydrides have different acyl groups. The anhydride is selected from the group consisting of aromatic anhydrides, alicyclic anhydrides, aliphatic anhydride and combinations thereof.

Examples of aromatic anhydrides include, but are not limited to, 3,3′,4,4′-benzophenonetetracarboxylic dianhydride, pyromellitic anhydride, and combinations thereof. Examples of alicyclic anhydrides include, but are not limited to methyltetrahydrophthalic anhydride, tetrahydrophthalic anhydride, methyl nadic anhydride, hexahydrophthalic anhydride, methylhexahydrophthalic anhydride, and combinations thereof. Examples of aliphatic anhydrides include, but are not limited to propionic anhydride, acetic anhydride, and combinations thereof.

The hardener component can be 20 to 100 parts per hundred parts of resin component to 100 parts per hundred parts of resin component. For example, the hardener component can be 20 parts per hundred parts of resin component to 100 parts per hundred parts of resin component, 20 parts per hundred parts of resin component to 55 parts per hundred parts of resin component, 100 parts per hundred parts of resin component to 100 parts per hundred parts of resin component, or another ratio.

The B-stageable formulations can include a solvent. Examples of solvents include, but are not limited to, ketones, amides, alcohols, esters, and combinations thereof. Examples of ketones include, but are not limited to, acetone, methyl ethyl ketone, cyclohexanone, and combinations thereof. Examples of amides include, but are not limited to, dimethylformamide, dimethylacetamide, N-methylpyrrolidinone, and combinations thereof. Examples of alcohols include, but are not limited to, methanol, ethanol, isopropanol, Dowanol™ PM, and combinations thereof. Examples of esters include, but are not limited to, methyl acetate, ethyl acetate, Dowanol™ PMA, and combinations thereof. For one or more of the embodiments, the solvent can be 20 weight percent or greater of a total weight of the B-stageable formulations. For example, the solvent can be 20 weight percent, 25 weight percent, or 30 weight percent of a total weight of the B-stageable formulations. For one or more of the embodiments, the solvent can be 60 weight percent or less of a total weight of the B-stageable formulations. For example, the solvent can be 60 weight percent, 55 weight percent, or 50 weight percent of a total weight of the B-stageable formulations. For one or more of the embodiments, the solvent can be, for example, 20 weight percent to 60 weight percent of a total weight of the B-stageable formulations, 25 weight percent to 55 weight percent of a total weight of the B-stageable formulations, or 30 weight percent to 50 weight percent of a total weight of the B-stageable formulations. The resin component and/or the hardener component can be dissolved in the solvent to form a solution.

For one or more of the embodiments, the B-stageable formulations can include a diluent. The diluent can be a non-reactive diluent or a reactive diluent depending upon the application. A non-reactive diluent is a compound that does not participate in a chemical reaction with the epoxy compound during the curing process. A reactive diluent is a compound which participates in a chemical reaction with the epoxy compound during the curing process.

For one or more of the embodiments, the B-stageable formulations can include a B-stageable formulation additive. Examples of B-stageable formulation additives include, but are not limited to, a modifier, an accelerator, a diluent, a flow control additive, a pigment, a reinforcing agent, a filler, an elastomer, a stabilizer, an extender, a plasticizer, a toughening agent, a flame retardant, and combinations thereof.

For one or more of the embodiments, the B-stageable formulations can have a pot life at 80° C. of 10 minutes or greater. For example, the B-stageable formulations can have a pot life at 80° C. of 10 minutes, 15 minutes, or 20 minutes. For one or more of the embodiments, the B-stageable formulations can have a pot life at 80° C. of 300 minutes or less. For example, the B-stageable formulations can have a pot life at 80° C. of 300 minutes, 250 minutes, or 200 minutes. For one or more of the embodiments, the B-stageable formulations can have a pot life at 80° C. of, for example, 10 minutes to 300 minutes, 15 minutes to 250 minutes, or 20 minutes to 200 minutes. For some embodiments it can be desirable for the B-stageable formulations to have a pot life at 80° C. of 60 minutes to 120 minutes. Pot life, as used herein, refers to a period of time, at a given temperature, that a mixture of the resin component and the hardener component remains workable for a particular application. One method of determining pot life includes placing a 100 gram mixture of a resin component and a hardener component into a container. A coiled steel wire moves up and down through the mixture. As the viscosity of the mixture increases during curing, the wire, at some point, is no longer able to move through the mixture. The mixture and the container are lifted to activate a switch. The pot life can be defined as the time period beginning when the resin component and the hardener component are mixed and ending when the switch is activated.

For one or more of the embodiments, a product obtained by curing the B-stageable formulations can have a glass transition temperature of at least 40° C. or greater. For example, the product obtained by curing the B-stageable formulations can have a glass transition temperature of at least 40° C., 60° C., or 80° C. For one or more of the embodiments, a product obtained by curing the B-stageable formulations can have a glass transition temperature of 140° C. or less. For example, the product obtained by curing the B-stageable formulations can have a glass transition temperature of 140° C., 130° C., or 120° C. or less. For one or more of the embodiments, a product obtained by curing the B-stageable formulations can have a glass transition temperature of, for example, 40° C. to 140° C., 60° C. to 120° C., or 80° C. to 100° C.

The prepreg reinforcement component can be a fiber. Examples of fibers include, but are not limited to, glass, aramid, carbon, polyester, polyethylene, quartz, basalt, metal, ceramic, biomass, and combinations thereof. The fibers can be coated. Examples of fiber coating include, but are not limited to, boron, trimethyl siloxysilicate (TMS)-glycidylethers, TMS-ethylenamines, diglycidylethers, precursors thereof, and combinations thereof.

Examples of glass fibers include, but are not limited to, A-glass fibers, E-glass fibers, C-glass fibers, R-glass fibers, S-glass fibers, T-glass fibers, and combinations thereof. Aramids are organic polymers, examples of which include, but are not limited to, Kevlar®, Twaron®, and combinations thereof. Examples of carbon fibers include, but are not limited to, those fibers formed from polyacrylonitrile, pitch, rayon, cellulose, and combinations thereof. Examples of metal fibers include, but are not limited to, stainless steel, chromium, nickel, platinum, titanium, copper, aluminum, beryllium, tungsten, and combinations thereof. Examples of ceramic fibers include, but are not limited to, those fibers formed from aluminum oxide, silicon dioxide, zirconium dioxide, silicon nitride, silicon carbide, boron carbide, boron nitride, silicon boride, and combinations thereof. Examples of biomass fibers include, but are not limited to, those fibers formed from wood, non-wood, and combinations thereof.

For one or more embodiments, the prepreg reinforcement component can be a fabric. The fabric can be formed from the fiber as discussed herein. Examples of fabrics include, but are not limited to, stitched fabrics, woven fabrics, and combinations thereof. The fabric can be unidirectional and/or multiaxial. The prepreg reinforcement component can be a combination of the fiber and the fabric.

The prepreg can be formed by contacting the prepreg reinforcement component and the prepreg matrix component via rolling, dipping, spraying, or some other procedure. After the prepreg reinforcement component has been contacted with the prepreg matrix component, the solvent can be removed via volatilization. While and/or after the solvent is volatilized the prepreg matrix component can be partially cured. This volatilization of the solvent and/or the partial curing can be referred to as B-staging. The B-staged product can be referred to as the prepreg. For some applications, B-staging can occur via an exposure to a temperature of 60° C. or greater. For example B-staging can occur via an exposure to a temperature of 60° C., 80° C., 100° C., or even a greater temperature. For some applications, B-staging can occur via an exposure to a temperature of 210° C. or less. For example B-staging can occur via an exposure to a temperature of 210° C., 190° C., 170° C., or even a lesser temperature. For some applications, B-staging can occur via an exposure to a temperature of, for example, 60° C. to 210° C., 80° C. to 190° C., or 100° C. to 170° C. For some applications, B-staging can occur for a period of time of 1 minute or more. For example, B-staging can occur for a period of time of 1 minute, a period of time of 3 minutes, a period of time of 5 minutes, or even a greater period of time. For some applications, B-staging can occur for a period of time of 15 minute or less. For example, B-staging can occur for a period of time of 15 minutes, a period of time of 13 minutes, a period of time of 11 minutes, or even a lesser period of time. For some applications, B-staging can occur for a period of time, for example, of 1 minute to 15 minutes, 3 minutes to 13 minutes, or 5 minutes to 11 minutes. For one or more embodiments, B-staging can occur via an exposure to a temperature of 60° C. to 210° C. for a period of time of 1 minute to 15 minutes. However, for some applications the B-staging can occur at another temperature and/or another period of time.

For one or more embodiments, the prepreg is latent at an ambient temperature of 20° C. and a relative humidity of 50%. The prepreg may also be latent at other temperatures and relative humidities. For example, the prepreg may be latent at a temperature less than 20° C., such as 15° C., 10° C., or even a lower temperature. The prepreg may be latent at temperature greater than 20° C., such as 25° C., 30° C., or even a higher temperature. The prepreg may be latent at a temperature of, for example, 10° C. to 30° C., or 15° C. to 25° C. The prepreg may be latent at a relative humidity of less than 50%. For example, the prepreg may be latent a relative humidity of less than 50%, such as 45%, 40%, or even a lower relative humidity. The prepreg may be latent at a relative humidity greater than 50%, such as 55%, 60%, or even a higher a relative humidity. The prepreg may be latent at a relative humidity of, for example, 40% to 60%, or 45% to 55%. As used herein, latent refers to having a substantially retarded rate of chemical reaction. This latency can help provide that the prepreg is storable at a temperature of 15° C. to 25° C., more preferably 18° C. to 22° C., or more preferably 20° C. and a relative humidity of 40% to 60%, more preferably 45% to 55%, or more preferably 50% for up to 30 days, more preferably 60 days, or more preferably 90 days while maintaining properties that contribute to the usefulness of the prepreg for forming the composites. For various applications the prepreg may be stored at various temperatures and/or various humidities while maintaining properties that contribute to the usefulness of the prepreg for forming the composite. For example, when stored at a temperature of −36° C. to 0° C., more preferably −27° C. to −9° C., or more preferably −18° C. the prepreg can maintain properties that contribute to the usefulness of the prepreg for forming the composite for 6 months, more preferably 9 months, or more preferably 12 months, or even longer.

For one or more embodiments, the methods of forming the composites can include covering a portion of the foam core with the prepreg. Prepregs can be layered and/or formed into a shape that covers a portion of the foam core. Prepreg layers can then be exposed to conditions that cause the prepreg matrix component becomes more fully cured. The conditions that cause the prepreg matrix component becomes more fully cured can include a temperature and a period of time. For some applications, the prepreg layers can be exposed to a temperature of 50° C. or greater, such as 55° C., 60° C., or a greater temperature. For some applications, the prepreg layers can be exposed to a temperature of 90° C. or less, such as 85° C., 80° C., or a lesser temperature. For some applications, the prepreg layers can be exposed to a temperature of, for example, 50° C. to 90° C., 55° C. to 85° C., or 60° C. to 80° C. For some applications, the prepreg layers can be exposed to the temperature for a period of time of 10 minutes or greater, such as 20 minutes, 30 minutes, or a greater period of time. For some applications, the prepreg layers can be exposed to the temperature for a period of time of 500 minutes or less, such as 450 minutes, 400 minutes, or a lesser period of time. For some applications, the prepreg layers can be exposed to the temperature for a period of time of, for example, 10 minutes to 500 minutes, 20 minutes to 450 minutes, or 30 minutes to 400 minutes. For one or more embodiments, the prepregs layers can be exposed to a temperature of 50° C. to 90° C. for a period of time of 10 minutes to 500 minutes. In this curing process the prepreg matrix component can flow and mix with the prepreg matrix component on adjacent layers thereby fusing the layers together. For one or more embodiments the prepreg has a heat of reaction that is 100 joules per gram or less. For example, the prepreg can have a heat of reaction of 100 joules per gram, 95 joules per gram, or 90 joules per gram. For one or more embodiments the prepreg has a heat of reaction that is 50 joules per gram or greater. For example, the prepreg can have a heat of reaction of 50 joules per gram, 55 joules per gram, or 60 joules per gram. For one or more embodiments the prepreg has a heat of reaction from, for example, 50 to 100 joules per gram, 55 to 95 joules per gram, or 60 to 90 joules per gram. For one or more embodiments the prepreg has a peak exotherm that is 50° C. or less in an adiabatic process. For example, the prepreg can have a peak exotherm that is 50° C., 45° C., or 42° C. in an adiabatic process. For one or more embodiments the prepreg has a peak exotherm that is 30° C. or greater in an adiabatic process. For example, the prepreg can have a peak exotherm that is 30° C., 35° C., or 38° C. in an adiabatic process. For one or more embodiments, the prepreg can have a peak exotherm that is in a range of, for example, 30° C. to 50° C., 35° C. to 45° C., or 38° C. to 42° C. in an adiabatic process.

For one or more embodiments, the methods of forming the composites can include an infusion process. Some infusion processes utilize a mold that is injected with a curable composition. The curable composition can be considered an infusion process matrix component. Examples of infusion processes include, but are not limited to, VARTM—Vacuum Assisted Resin Transfer Molding, VARIM—Vacuum Assisted Resin Infused Molding, SCRIMP—Seemann Composites Resin Infusion Molding Process, VBRTM—Vacuum Bag Resin Transfer Molding, and VARI—Vacuum Assisted Resin Infusion process.

For one or more of the embodiments, the methods of forming the composites can include providing a mold. The mold can have different sizes, shapes, and/or compositions for different applications. The size, shape, and/or composition of the mold can depend upon the composite being formed and/or the infusion process being employed. The mold can contain the foam core and the prepreg that covers a portion of the foam core.

The infusion process can include an infusion process reinforcement component. The infusion process reinforcement component can be the fiber, the fabric, or combinations thereof, as discussed for the prepreg reinforcement component. For one or more embodiments, the method of forming the composite can include contacting the prepreg that covers the portion of the foam core with the infusion process reinforcement component. The infusion process matrix component and the infusion process reinforcement component provide a synergism. This synergism provides properties that are unattainable with only the individual components.

For one or more embodiments, the methods of forming the composites can include contacting the prepreg that covers the portion of the foam core with the curable composition. For example, the curable composition can be infused into the infusion processes reinforcement component and contact the prepreg. The prepreg can be a barrier between the curable composition and the foam core. A pressure differential can be provided to transport the curable composition.

The curable compositions can include a curable composition resin component. The curable composition resin component can include one or more of the epoxy compounds discussed herein. For one or more embodiments, the curable composition resin component can have an epoxy equivalent weight of 150 grams per equivalent or greater. For example, the curable composition resin component can have an epoxy equivalent weight of 150 grams per equivalent, 175 grams per equivalent, or 200 grams per equivalent. For one or more embodiments, the curable composition resin component can have an epoxy equivalent weight of 300 grams per equivalent or less. For example, the curable composition resin component can have an epoxy equivalent weight of 300 grams per equivalent, 275 grams per equivalent, or 250 grams per equivalent. For one or more embodiments, the curable composition resin component can have an epoxy equivalent weight of, for example, 150 grams per equivalent to 300 grams per equivalent, 175 grams per equivalent to 275 grams per equivalent, or 200 grams per equivalent to 250 grams per equivalent.

The curable compositions can include a curable composition hardener component. The curable composition hardener component can be selected from the group consisting of amines, anhydrides, carboxylic acids, phenols, thiols, and combinations thereof.

For one or more of the embodiments, the curable compositions can include a curable composition additive. Examples of curable composition additives include, but are not limited to, those listed for the B-stageable formulation additives, as discussed herein.

For one or more embodiments, the methods of forming the composites can include curing the prepregs and the curable compositions to form the composites, wherein the prepregs insulate the foam cores during the curing so that the foam maintains a temperature that is below the softening point. The prepreg can prevent heat from reaching the foam core via melting and/or curing. For this curing, a portion of the curable composition can be heated to a temperature of 80° C. or greater. For example, a portion of the curable composition can be heated to a temperature of 80° C., 82° C., or 84° C. For this curing, a portion of the curable composition can be heated to a temperature of 90° C. or less. For example, a portion of the curable composition can be heated to a temperature of 90° C., 88° C., or 86° C. For this curing, a portion of the curable composition can be heated to a temperature of, for example, 80° C. to 90° C., 82° C. to 88° C., or 84° C. to 86° C. For one or more embodiments, the curable composition has a heat of reaction that is greater than 100 joules per gram. For example, the curable composition can have a heat of reaction of 101 joules per gram, 105 joules per gram, 115 joules per gram, or even a greater heat of reaction. For one or more embodiments, the curable composition has a heat of reaction that is 500 joules per gram or less. For example, the curable composition can have a heat of reaction of 500 joules per gram, 400 joules per gram, or 300 joules per gram. For one or more embodiments, the curable composition has a heat of reaction that is, for example 101 to 500 joules per gram, 105 to 400 joules per gram, or 115 to 300 joules per gram.

Curing, as discussed herein, is a chemical reaction between, the resin component and the hardener component. The chemical reaction is an exothermic chemical reaction that generates heat. Both the curing of the prepreg and the curing of the curable composition generate heat. However, the prepreg can function as a thermal insulator and/or heat sink to the foam core. The insulative effect of the prepreg can help provide that an external surface of the foam core does not reach a temperature whereby thermal degradation of the foam can occur.

### EXAMPLES

In the Examples, various terms and designations for materials were used including for example the following:

D.E.R.™ 330, (aromatic epoxy compound), available from The Dow Chemical Company.

D.E.N.™ 431, (aromatic epoxy compound), available from The Dow Chemical Company.

D.E.R.™ 354LV, (aromatic epoxy compound), available from The Dow Chemical Company.

D.E.R.™ 383, (aromatic epoxy compound), available from The Dow Chemical Company.

D.E.R.™ 732, (aliphatic epoxy compound), available from The Dow Chemical Company.

4,4′-Diaminodiphenyl sulphone, (aromatic polyamine), available from Atul Limited.

Sulfanilamide, (aromatic polyamine), available from Atul Limited.

Methyl hexahydrophthalic anhydride, (anhydride), available from Huntsman International.

2-methyl imidazole (catalyst), (analytical grade), available from Sinopharm Chemical Co.

Butanediol diglycidyl ether, (diluent), available from The Dow Chemical Company.

JEFFAMINE® D-230, (polyoxypropylenediamine), available from Huntsman International LLC.

Isophorone diamine, (amine), available from Evonik Industries.

Aminoethylpiperazine, (amine), available from The Dow Chemical Company.

VORANOL™ 220-028 (triol polyether polyol), available from The Dow Chemical Company.

Benzyl triethylamonium chloride, available from Sigma-Aldrich.

HYCATT™ OA, (chromium(III) carboxylate), available from Dimension Technology Chemical Systems, Inc.

Prepreg, NEMA G-10 grade (MIL P13949F, Type GE), available from The Dow Chemical Company. This prepreg can be made from: D.E.R.™ 331, (100 parts, aromatic epoxy compound), available from The Dow Chemical Company; 4,4′-Diaminodiphenyl sulphone, (30 parts, aromatic polyamine); and Boron Trifluoro-Mono-Ethylamine (1.5 parts, accelerator).

Glass fabric (bidiagonal, style number: S32EX010-00980-01270-283000), available from SAERTEX®.

COMPAXX™ (foam core), available from The Dow Chemical Company.

AIRSTONE™ 780E (aromatic epoxy compound), available from The Dow Chemical Company.

AIRSTONE™ 786H (amine), available from The Dow Chemical Company.

### Examples 1-9, B-Stageable Formulations

The B-stageable formulations, Examples 1-9, were prepared by combining a respective resin component and a respective hardener component at a room temperature of approximately 23° C. Some of the Examples also included a catalyst. The data in Table 1A shows the composition of Examples 1-9. Phr is parts per hundred resin based on 100 parts of resin component.

TABLE 1A

| | | | | Hardener Component | | | |
|---|---|---|---|---|---|---|---|
| | Resin Component | | | | | Methyl | Catalyst |
| Example | D.E.R. ™ | D.E.N. ™ | D.E.R. ™ | 4,4′-Diaminodiphenyl | | hexahydrophthalic | 2-methyl |
| # | 330 | 431 | 354 LV | sulphone | Sulfanilamide | anhydride | imidazole |
| Example 1 | 100 g | — | — | 31.6 phr | — | — | — |
| Example 2 | 100 g | — | — | — | 23.9 phr | — | — |
| Example 3 | 100 g | — | — | — | — | 46.7 phr | 0.1 phr |
| Example 4 | — | 1.54 g | — | 32.6 phr | — | — | — |
| Example 5 | — | 1.66 g | — | — | 24.6 phr | — | — |
| Example 6 | — | 1.28 g | — | — | — | 48.1 phr | 0.1 phr |
| Example 7 | — | — | 1.03 g | 34.3 phr | — | — | — |
| Example 8 | — | — | 1.24 g | — | 25.9 phr | — | — |
| Example 9 | — | — | 1.55 g | — | — | 50.6 phr | 0.1 phr |

Curable Composition 1

Curable composition 1 was prepared by combining a resin component and a hardener component at a room temperature of approximately 23° C. Table 1B shows the composition of curable composition 1.

TABLE 1B

| | Resin Component | | Hardener Component | | |
|---|---|---|---|---|---|
| | (100 parts) | | (30 parts) | | |
| | | Butanediol diglycidyl | JEFFAMINE ® | Isophorone | |
| Composition | D.E.R. ™ 330 | ether | D-230 | diamine | Aminoethylpiperazine |
| Curable | 86 | 14 | 73 | 13.5 | 13.5 |
| composition 1 | | | | | |

Some properties of Examples 1-9 and curable composition 1 were determined and are shown in Tables 2A, 2B, respectively. The viscosity at 20° C., 40° C., 60° C., and 80° C. was determined by ASTM D445; the pot life at 20° C. was determined by DIN 19645; the exotherm was determined by DIN 19645; and the glass transition temperature was determined by IEC 61006.

TABLE 2A

| | | | | | | | Glass |
|---|---|---|---|---|---|---|---|
| | | | | | Pot life | | transition |
| Example | Viscosity | | | | at 80° C. | Exotherm | temperature |
| # | 20° C. | 40° C. | 60° C. | 80° C. | (min) | (J/g) | (° C.) |
| Example 1 | — | 42.24 | 1.2 | 0.14 | 50 | 250 | 171.3 |
| Example 2 | — | 97.28 | 2.8 | 0.84 | 50 | 200 | 168.3 |
| Example 3 | 18.56 | 3.2 | — | — | 40 | 62 | 147 |
| Example 4 | — | >512 | 4.12 | 0.47 | 50 | 200 | 167 |
| Example 5 | — | >512 | 6.4 | 0.84 | 30 | 227 | 133 |
| Example 6 | >512 | 0.48 | — | — | — | — | 141.7 |
| Example 7 | 69.1 | 19.2 | 0.68 | — | 45 | 190 | 142.7 |
| Example 8 | — | 3.84 | 0.72 | — | 45 | 150 | 122 |
| Example 9 | 0.96 | 0.8 | — | — | 35 | 96 | 138.8 |

TABLE 2B

| | | Glass transition |
|---|---|---|
| | Exotherm | temperature |
| | (J/g) | (° C.) |
| Curable composition 1 | 485 | 82 |

The data in Tables 2A-2B shows that the B-stageable formulations, Examples 1-9, each have a lower exotherm as compared to curable composition 1. Additionally, the data in Tables 2A-2B shows that the B-stageable formulations, Examples 1-9, each have a higher glass transition temperature as compared to curable composition 1.

### Example 10

### B-Stageable Formulation

The B-stageable formulation, Example 10, was prepared by combining a resin component and a hardener component at a temperature of approximately 23° C. Table 3 shows the composition of Example 10.

TABLE 3

| | Resin Component (49 wt % of Example 10) | | | Hardener Component (51 wt % of Example 10) | | | |
|---|---|---|---|---|---|---|---|
| | | | Butanediol | Methyl | | Benzyl | |
| Example | D.E.R. ™ | D.E.R. ™ | diglycidyl | hexahydrophthalic | VORANOL ™ | triethylamonium | Hycat ™ |
| # | 383 | 732 | ether | anhydride | 220-028 | chloride | OA |
| Example | 70.0 | 15.0 | 15.0 | 83.9 | 10.7 | 4.4 | 1.0 |
| 10 | (wt % of | (wt % of | (wt % of | (wt % of | (wt % of | (wt % of | (wt % of |
| | resin | resin | resin | hardener | hardener | hardener | hardener |
| | component) | component) | component) | component) | component) | component) | component) |

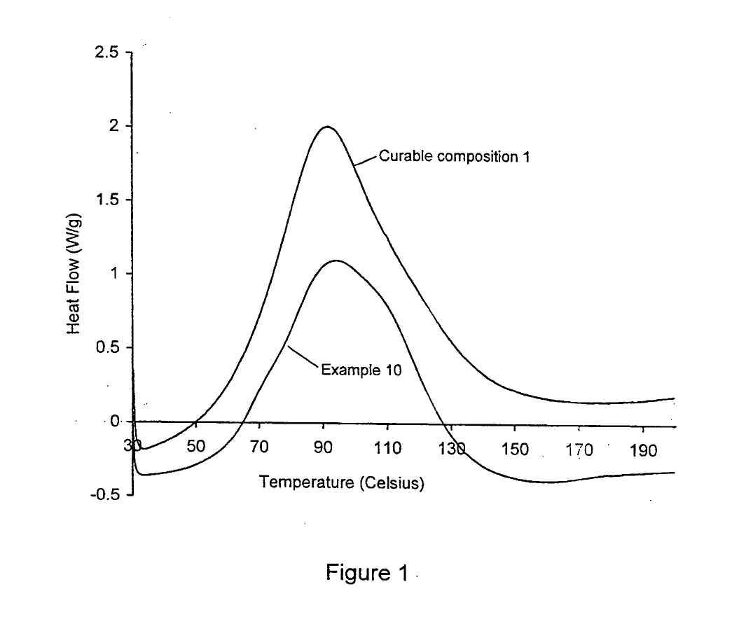

Heat flow data for curable composition 1 and Example 10 was determined by using differential scanning calorimetry (DSC) and are shown in FIG. 1. The data in FIG. 1 shows that curable composition 1 had a greater heat flow than Example 10. The enthalpy during curing of curable composition 1 and Example 10 was measured from areas, for curable composition 1 and Example 10 respectively, determined via DSC scans that included heating at a rate of 2° C./min (from 20° C. to 200° C.) on a TA Instruments DSC Q200. The areas were quantified using TA Instruments Universal Analysis 2000 software. The data in FIG. 1 shows that the heat evolved in curable composition 1 was 400 J/g while the heat evolved in Example 10 was 300 J/g.

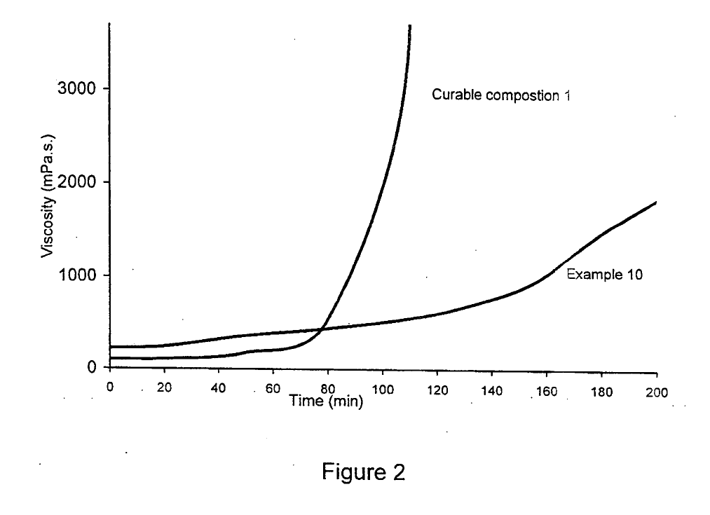

Viscosity increases at 40° C. for curable composition 1 and Example 10 were determined using an ARES rheometer, available from TA Instruments, and are shown in FIG. 2. 50 g of each curable composition 1 and Example 10 were placed in a 40° C. over, portions of which were withdrawn over time interval and used for viscosity measurement. The data in FIG. 2 shows that the viscosity of curable composition 1 increases to a higher value at a greater rate than the viscosity of Example 10.

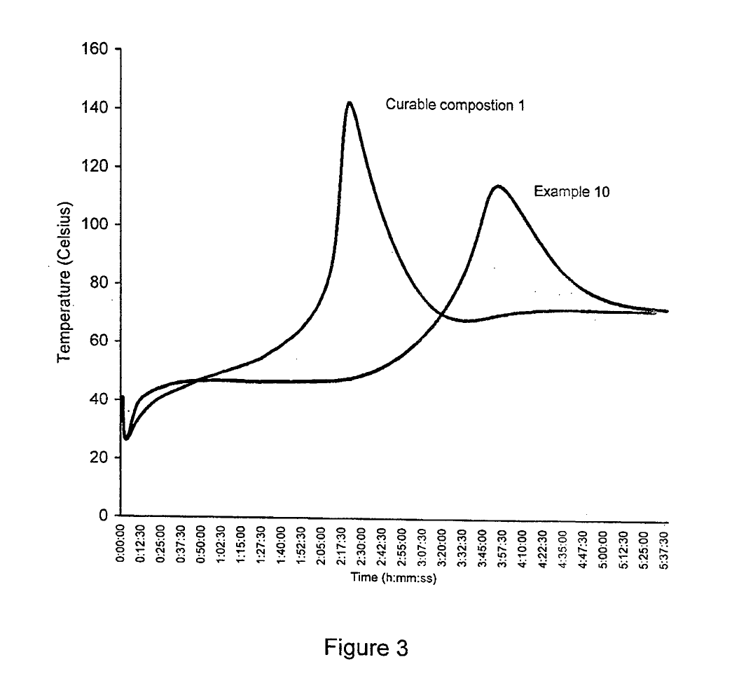

Exothermic cure temperatures for 100 g of curable composition 1 and 100 g of Example 10 were determined by placing 100 g of each of curable composition 1 and Example 10 into a respective container. A thermocouple, attached to a DataChart® 2000 digital data logger, was inserted into the container contents and the containers were placed in a 40° C. oven. The containers were maintained at 40° C. for 2 hours; thereafter the temperature was increased to 70° C. at a rate of 0.2° C. per minute. The containers were maintained at 70° C. for 1 hour. The results are shown in FIG. 3. The data in FIG. 3 shows that the peak cure temperature for 100 g of Example 10 is less than the peak cure temperature for 100 g of curable composition 1.

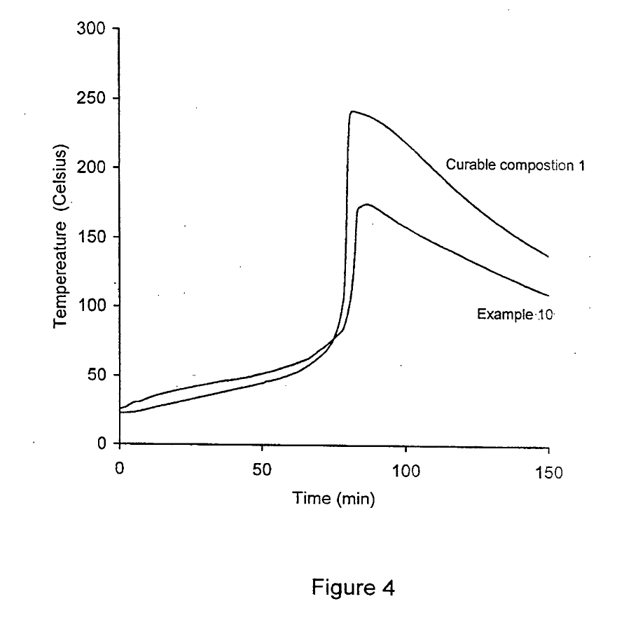

Exothermic cure temperatures for 1,000 g of curable composition 1 and 1,000 g of Example 10 were determined by as described above, however the data was generated by maintaining the containers at 40° C. for 4 hours. The results are shown in FIG. 4. The data in FIG. 4 shows that the peak cure temperature for 1,000 g of Example 10 is less than the peak cure temperature for 1,000 g of curable composition 1.

Some properties of a cured portion of curable composition 1 and a cured portion of Example 10 were determined. Tensile modulus was determined by ASTM D638; tensile strength was determined by ISO 527-2; strain at maximum load was determined by ISO 527-2; strain at break was determined by ISO 527-2; flexural modulus was determined by ASTM D790; flexural strength was determined by ASTM D790; fracture toughness was determined by ASTM E1290-09; and heat deflection temperature was determined by ASTM D648. Tables 4A and 4B show the results of the aforementioned tests for curable composition 1 cured portion and Example 10 cured portion, respectively.

TABLE 4A

| | | | | | Glass | | | | | | Heat |
|---|---|---|---|---|---|---|---|---|---|---|---|
| | Tensile | Tensile | Strain at | Strain | transition | Flex | Flex | Strain at | Strain | Fracture | deflection |
| | modulus | strength | maximum | at break | temperature | modulus | strength | maximum | at break | toughness | temperature |
| | (Gpa) | (Mpa) | load (%) | (%) | (° C.) | (Gpa) | (Mpa) | load (%) | (%) | (MPa · m^{1/2}) | (° C.) |
| Cured | 3.2 ± 0.1 | 69.0 ± 0.3 | 5.4 ± 0.1 | 9.1 ± 0.8 | 88 | 3.1 ± 0.2 | 117 ± 6 | 6.4 ± 0.1 | 8.9 ± 1.8 | 0.96 ± 0.1 | 75 |
| portion | | | | | | | | | | | |
| of curable | | | | | | | | | | | |
| composition | | | | | | | | | | | |
| 1 | | | | | | | | | | | |

TABLE 4B

| | | | | | Glass | | | | | | Heat |
|---|---|---|---|---|---|---|---|---|---|---|---|
| | Tensile | Tensile | Strain at | Strain | transition | Flex | Flex | Strain at | Strain | Fracture | deflection |
| | modulus | strength | maximum | at break | temperature | modulus | strength | maximum | at break | toughness | temperature |
| | (Gpa) | (Mpa) | load (%) | (%) | (° C.) | (Gpa) | (Mpa) | load (%) | (%) | (MPa · m^{1/2}) | (° C.) |
| Cured | 3.7 ± 0.1 | 64.0 ± 0.3 | 4.3 ± 0.1 | 7.9 ± 0.8 | 88 | 3.1 ± 0.2 | 113 ± 6 | 5.4 ± 0.1 | 8.5 ± 1.8 | 1.1 ± 0.1 | 72 |
| portion of | | | | | | | | | | | |
| Example 10 | | | | | | | | | | | |

The values in Table 4C show some Germanischer Lloyd (GL) Specification limits.

TABLE 4C

| | | | | Glass | | Heat |
|---|---|---|---|---|---|---|
| | Tensile | Tensile | Strain | transition | Flex | deflection |
| | modulus | strength | at break | temperature | strength | temperature |
| | (Gpa) | (Mpa) | (%) | (° C.) | (Mpa) | (° C.) |
| GL | 2.7 | 55 | 2.5 | 70 | 100 | 70 |
| Specification | | | | | | |

The data in Table 4A shows that the cured portion of curable composition 1 and the cured portion of Example 10 had properties conforming to GL Specification values for tensile modulus, tensile strength, strain at break, glass transition temperature, flex strength, and heat deflection temperature.

### Example 11

### Composite

A foam core that was a rectangular block (approximately 225 g) of Compaxx™ having top surface dimensions of 34 cm by 69 cm, bottom surface dimensions of 40 cm by 75 cm, and beveled sides that allowed glass fabric to contact the entire block was encapsulated in two layers SAERTEX® bidiagonal glass fabric. One layer of prepreg (NEMA G-10) encapsulated the foam core and the glass fabric. The encapsulated foam core was sealed in vacuum film, placed upon a heating table, and connected to a vacuum pump. The heating table was heated to and maintained at 30° C. Three hundred seventy nine grams of AIRSTONE™ 780E and 121 grams of AIRSTONE™ 786H were heated to 40° C. and then mixed to form a curable composition. During the mixing the curable composition had a temperature of 30° C. A vacuum of 5 millibar (mbar) was applied and the curable composition was infused. After one hour the temperature of the heating table was ramped to 70° C. at a rate of 1° C. per minute. After 120 minutes at 70° C. the vacuum pump was shut off, thereafter the heating table was maintained at 70° C. to provide Example 11, a composite. The temperatures of the heating table, the glass fabric, the surface of the foam core, and the curable composition were monitored, the results of which are shown in Table 5A.

TABLE 5A

| | | | Foam Core | Curable |
|---|---|---|---|---|
| | Heating Table | Glass Fabric | Surface | Composition |
| Time | Temperature | Temperature | Temperature | Temperature |
| (minutes) | (° C.) | (° C.) | (° C.) | (° C.) |
| 0 | 39.5 | 36.5 | 24.0 | 28.0 |
| 7 | 40.5 | 40.0 | 25.5 | 28.0 |
| 15 | 41.0 | 40.0 | 26.0 | 28.0 |
| 23 | 41.0 | 40.5 | 26.5 | 29.5 |
| 30 | 42.0 | 41.5 | 26.0 | 31.5 |
| 40 | 42.0 | 41.5 | 25.0 | 33.5 |
| 60 | 43.5 | 42.5 | 24.5 | 34.0 |
| 70 | 51.5 | 50.0 | 25.0 | 33.5 |
| 80 | 59.5 | 58.0 | 26.0 | 34.0 |
| 90 | 61.0 | 59.5 | 26.5 | 34.5 |
| 105 | 70.0 | 68.5 | 27.5 | 38.5 |
| 120 | 70.0 | 68.5 | 28.5 | 40.0 |
| 135 | 70.0 | 68.5 | 28.5 | 40.0 |
| 150 | 70.5 | 69.0 | 29.0 | 40.5 |
| 165 | 70.5 | 69.0 | 29.0 | 39.5 |
| 180 | 70.5 | 69.0 | 29.5 | 40.5 |

### Comparative Example A

Comparative Example A, a composite, was formed as Example 11 with the change that no prepreg was used for Comparative Example A. The temperatures of the heating table, the glass fabric, the surface of the foam core, and the curable composition were monitored, the results of which are shown in Table 5B.

TABLE 5B

| | | | Foam Core | Curable |
|---|---|---|---|---|
| | Heating Table | Glass Fabric | Surface | Composition |
| Time | Temperature | Temperature | Temperature | Temperature |
| (minutes) | (° C.) | (° C.) | (° C.) | (° C.) |
| 0 | 38 | 35.5 | 26.5 | 27.5 |
| 20 | 41.5 | 41.5 | 27 | 30 |
| 35 | 42.5 | 42.5 | 27 | 32.5 |
| 70 | 44.5 | 45.5 | 29.5 | 39.5 |
| 100 | 60.5 | 63.5 | 32.5 | 54 |
| 130 | 60.5 | 64 | 38 | 63 |
| 190 | 70.5 | 73 | 45 | 62.5 |
| 220 | 71 | 72 | 44.5 | 60 |
| 270 | 70.5 | 73.5 | 47.5 | 59 |

The data in Tables 5A-5B shows that the foam core surface temperature of Example 11 was lower than the foam core surface temperature of Comparative Example A at corresponding times during the respective cures. The data in Tables 5A-5B shows that the prepreg can function as a thermal insulator and/or heat sink to the foam core.

1. A method of forming a composite, comprising:
providing a foam core, wherein the foam core includes a foam having a softening point of 90° C. to 110° C. as determined by ASTM D1525;
covering a portion of the foam core with a prepreg;
contacting the prepreg that covers the portion of the foam core with a curable composition; and
curing the prepreg and the curable composition to form the composite, wherein the prepreg insulates the foam core during the curing so that the foam maintains a temperature that is below the softening point.

2. The method of claim 1, wherein the prepreg has a heat of reaction of 100 joules per gram or less and is obtainable by:
combining:
a resin component including;
an epoxy compound that is selected from the group consisting of aromatic epoxy compounds, alicyclic epoxy compounds, aliphatic epoxy compounds, and combinations thereof; and
a hardener component that is selected from the group consisting of amines, anhydrides, and combinations thereof to obtain a B-stageable formulation; and
exposing the B-stageable formulation to a temperature of 60° C. to 210° C. for a period of time of 1 minute to 15 minutes.

3. The method of claim 1, wherein the foam is selected from the group consisting of polystyrene foam, polyvinyl chloride foam, polyurethane foam, styrene-acrylonitrile foam, polymethacrylamide foam, polyethylene terephthalate foam, and combinations thereof.

4. The method of claim 1, wherein the curable composition has a heat of reaction that is greater than 100 joules per gram and is obtainable by:
combining:
a resin component having;
an epoxy compound that is selected from the group consisting of aromatic epoxy compounds, alicyclic epoxy compounds, aliphatic epoxy compounds, and combinations thereof; and
a hardener component that is selected from the group consisting of amines, anhydrides, carboxylic acids, phenols, thiols, and combinations thereof.

5. The method of claim 1, further comprising providing a mold, wherein the mold contains the foam core and the prepreg that covers a portion of the foam core.

6. The method of claim 1, wherein exposing the covered portion of the foam core to the curable composition includes providing a pressure differential to transport the curable composition.

7. The method of claim 1, where providing the foam core includes providing a thermoplastic polymeric foam having a softening point of 90° C. to 110° C.

8. A composite obtained by curing the prepreg and the curable composition of claim 1.

9. A B-stageable formulation comprising:
a resin component having;
an epoxy compound that is selected from the group consisting of aromatic epoxy compounds, alicyclic epoxy compounds, aliphatic epoxy compounds, and combinations thereof; and
a hardener component that is selected from the group consisting of amines, anhydrides, and combinations thereof, wherein the resin component has an epoxy equivalent weight of 400 grams per equivalent to 500 grams per equivalent, the hardener component has a hydrogen equivalent weight of 40 grams per equivalent to 240 grams per equivalent, and the hardener component is 20 parts per hundred parts of resin component to 55 parts per hundred parts of resin component.

10. The B-stageable formulation of claim 9, wherein the B-stageable formulation has a pot life at 80° C. of 10 minutes to 300 minutes and upon B-staging via exposure to a temperature of 60° C. to 210° C. for a period of time of 1 minute to 15 minutes a heat of reaction that is from 50 to 100 joules per gram.
